(19) United States
(12) Patent Application Publication
(10) Pub. No.: US 2008/0099433 A1
(43) Pub. Date: May 1, 2008

(54) Automatic positioning/engraving method for laser engraving machine

(75) Inventors: Hans Huang, Hsi Chih City (TW); Jeff Lee, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/589,307

(22) Filed: Oct. 30, 2006

(51) Int. Cl. B41C 1/02

(52) U.S. Cl. 216/54

(57) ABSTRACT

In the automatic positioning/engraving method for a laser engraving machine, a pattern to be used for engraving is framed with a quadrilateral frame, then a first and a second coordinate position of two mutually opposite ends of a diagonal line of the quadrilateral frame are obtained by measuring; a pen carriage on the laser engraving machine is moved to be above a workpiece to position a first positioning point in coincidence with the first coordinate position and a second positioning point in coincidence with the second coordinate position; and a processor is used to calculate to decide a center between the first and the second positioning points according to the coordinate values of the first and the second positioning points, and a driving unit is used to move the pen carriage to the center for starting pattern engraving.

### BACKGROUND OF THE INVENTION

1. Field of the Invention

The present invention is related to a laser engraving machine; and especially to an automatic positioning/engraving or cutting method in which a first positioning point and a second positioning point are set on a workpiece, and then a processor is used to calculate to decide a center between the first and the second positioning points, and a driving unit is used to move a pen carriage to the center for starting pattern engraving or cutting.

2. Description of the Prior Art

The process of laser engraving or cutting is very simple; like the printing on a paper with a computer and a printer, it needs only to edit patterns, and then the patterns can be printed through a computer onto a laser engraving machine. The sole difference is: printing applies powder ink onto a paper, while laser engraving projects laser onto a wooden article, acryl, plastic plate, metallic plate or stone and the procedure of engraving can simply be completed.

Before a process of laser engraving in a conventional way, a workpiece is positioned on a processing platform, after the a center of a pattern to be processed is obtained by measuring with a ruler, the pen carriage of the laser engraving system is manually moved to the center of the workpiece; when the center of the pattern is projected onto the workpiece, the position that the pattern is to be shaped on the workpiece is confirmed. However, the work of positioning the center normally is obtained by measuring with a ruler on the workpiece, or is obtained roughly by visual estimation; during the operation of engraving, the pattern may be subjected to exceeding the margins of the workpiece, this makes unable of getting the complete pattern; or the pattern may be too small that it is too far away from the margins of the workpiece, although the pattern can be obtained completely on the workpiece by engraving, a part of material of the workpiece may be wasted.

In view of the above stated, to get rid of the defects, the inventor of the present invention studied hard to develop the present invention based on his years of experiences, in which the automatic positioning/engraving method for a laser engraving machine not only can save the time for manual positioning, but also can avoid the error induced by such manual positioning, and the position for processing a pattern can be accurately positioned, the cost of material can be saved as well.

### SUMMARY OF THE INVENTION

The primary object of the present invention is to provide an automatic positioning/engraving method for a laser engraving machine, wherein a first positioning point and a second positioning point are set on a workpiece, and then a processor is used to calculate to decide a center between the first and the second positioning points, then a pen carriage is automatically moved to the center to start pattern engraving or cutting, thus the pattern can be formed on a workpiece, this can save the time for manual positioning, and can avoid the error induced by man work.

To achieve the above objective, the automatic positioning/engraving method for a laser engraving or cutting machine of the present invention includes the following steps:

a. to provide a pattern to be used for engraving or cutting, to frame the pattern with a quadrilateral frame, to obtain by measuring a first and a second coordinate position of two mutually opposite ends of a diagonal line of the quadrilateral frame;
b. to provide a workpiece, to move a pen carriage of the laser engraving or cutting machine to be above the workpiece to position a first positioning point in coincidence with the first coordinate position; (In an embodiment, this can be done by using a red beam emitting device installed on the machine as a reference so that a red beam is emitted through the pen carriage and will move along with the moving of the pen carriage and the coordinates of the positioning points can be obtained by aligning the red beam onto the positioning points.)
c. to move the pen carriage to position a second positioning point in coincidence with the second coordinate position; and
d. to provide a processor to calculate to decide a center between the first and the second positioning points, and to use a driving unit to move the pen carriage to the center for starting pattern engraving or cutting.

The present invention will be apparent after reading the detailed description of the preferred embodiment thereof in reference to the accompanying drawings.

### BRIEF DESCRIPTION OF THE DRAWINGS

FIG. 1 is a process flow chart of an embodiment of the present invention;

FIG. 2 is a schematic view showing a step a of the embodiment of the present invention;

FIG. 3 is a schematic view showing steps b and c of the embodiment of the present invention;

FIG. 4 is a schematic view showing a step d of the embodiment of the present invention.

### DETAILED DESCRIPTION OF THE PREFERRED EMBODIMENT

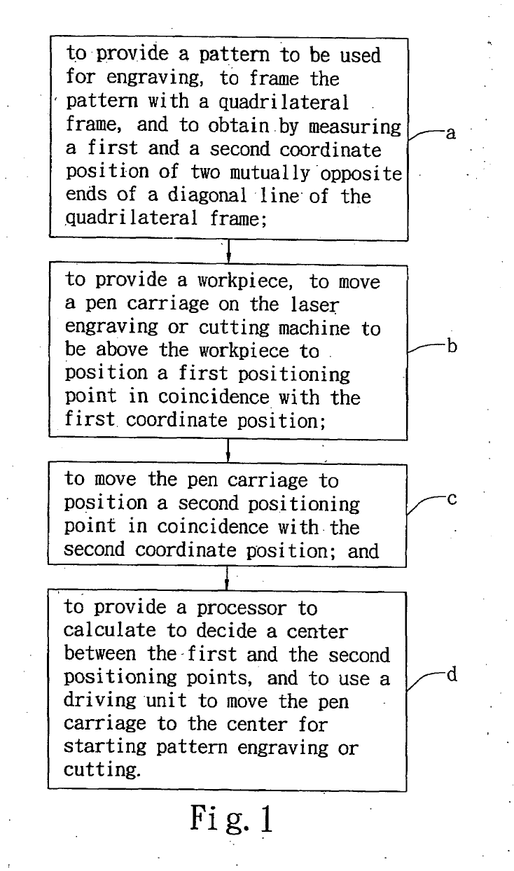

Referring firstly to FIG. 1 showing an embodiment of the automatic positioning/engraving method for a laser engraving machine of the present invention, the method includes the following steps:

a. to provide a pattern to be used for engraving, to frame the pattern with a quadrilateral frame, and to obtain by measuring a first and a second coordinate position of two mutually opposite ends of a diagonal line of the quadrilateral frame;

b. to provide a workpiece, to move a pen carriage on the laser engraving or cutting machine to be above the workpiece to position a first positioning point in coincidence with the first coordinate position;

c. to move the pen carriage to position a second positioning point in coincidence with the second coordinate position; and

d. to provide a processor to calculate to decide a center between the first and the second positioning points, and to use a driving unit to move the pen carriage to the center for starting pattern engraving or cutting.

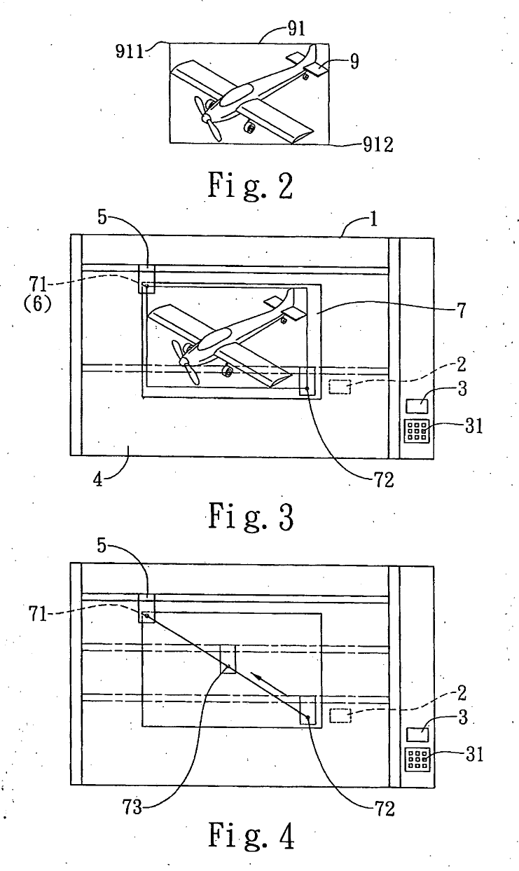

Referring to FIG. 2 which is a schematic view showing a step a of the present invention, wherein a pattern 9 to be processed for engraving or cutting is completed in the first place by editing with a computer, then a quadrilateral frame 91 is used to totally frame the pattern 9, then the width and length of the quadrilateral frame 91 is measured on the screen of the computer or with a ruler to determine the positions of the first and the second coordinate positions 911, 912 of the two mutually opposite ends of a diagonal line of the quadrilateral frame 91.

Referring to FIG. 3 which is a schematic view showing the steps b and c of the embodiment of the present invention, wherein a laser engraving machine 1 is provided on one lateral side thereon with a processor 2, a screen 3 and a keyboard 31, a platform 4 of the laser engraving machine 1 is provided thereon with a pen carriage 5 that can be moved transversely and longitudinally, the pen carriage 5 has therein an infrared emitter/receiver 6. A workpiece 7 being a plain plate is positioned on the platform 4 of the laser engraving machine 1. When the pen carriage 5 is moved to be above the workpiece 7, the infrared emitter of the pen carriage 5 emits infrared ray downwards, when the infrared receiver receives the infrared ray after being reflected, the information on the coordinate of the position being radiated by the infrared ray is transmitted to the processor 2, and meantime is displayed on the screen 3; in this way, a first positioning point 71 in coincidence with the first coordinate position 911 is decided. When the pen carriage 5 is moved to a second positioning point 72 in coincidence with the second coordinate position 912, the coordinate values of the second positioning point 72 are shown on the screen 3. As shown in FIG. 4, in the step d, the processor 2 is used to calculate to decide a center 73 between the first and the second positioning points 71, 72 according to the coordinate values of the first and the second positioning points 71, 72. When the coordinate position of the center 73 is obtained, the processor 2 is used to activate a servo motor that can drive the pen carriage 5 to move longitudinally and a servo motor that can drive the pen carriage 5 to move transversely, in order to move the pen carriage 5 to the center 73 to be used as a reference point for engraving or cutting and to start pattern engraving or cutting operation. The above mentioned two servo motors to drive the pen carriage 5 to move longitudinally and transversely are used as a driving unit (not shown). In practicing, the mode of positioning for the steps b and c can also be one that uses an infrared emitter to emit infrared ray, when the emitter irradiates the platform 4, a store key on the keyboard 31 is pressed down, and the processor 2 reads the data fed back from the driving unit to decide the coordinate position of the pen carriage 5, and the coordinate values of the coordinate position are displayed on the screen 3. With such a mode, the coordinate values of the first and the second positioning points 71, 72 can be accurately obtained, and by the operation and control of the processor 2, the pen carriage 5 can be moved to the position of the center 73 to start pattern engraving or cutting operation.

Therefore, the present invention has the following advantages:
1. The present invention makes accurate positioning of the pen carriage by operation of the processor and action of the driving unit, it not only can effectively save the time for manual positioning, but also can avoid the error induced by such manual positioning to increase the superiority of products.
2. The present invention makes accurate positioning of the pen carriage by using an accurate positioning structure, during the operation of engraving or cutting, not only the situation of exceeding margins of the workpiece can be avoided to not result waste products, but also carving of the pattern can be made at the predetermined positions under control which can avoid too much space being not carved, so that cost of material can be reduced.

In conclusion, according to the above disclosed content, the present invention surely can accomplish the expected object to provide an automatic positioning/engraving or cutting method for a laser carving machine. To the method not only can save the time for manual positioning, but also can avoid the error induced by such manual positioning, and can accurately decide the position for processing a pattern, and can save the cost of material as well. Having thus described the technical process of my invention having practical industrial value, what I claim as new and desire to be secured by Letters Patent of the United States is:

1. An automatic positioning/engraving method for a laser engraving machine, said method includes the following steps:
a. to provide a pattern to be used for engraving or cutting, to frame said pattern with a quadrilateral frame, to obtain by measuring a first and a second coordinate position of two mutually opposite ends of a diagonal line of said quadrilateral frame;
b. to provide a workpiece, to move a pen carriage on said laser engraving machine to be above said workpiece to position a first positioning point in coincidence with said first coordinate position;
c. to move said pen carriage to position a second positioning point in coincidence with said second coordinate position; and
d. to provide a processor to calculate to decide a center between said first and said second positioning points, and to use a driving unit to move said pen carriage to said center for starting pattern engraving or cutting.

2. The automatic positioning/engraving method for a laser engraving machine as in claim 1, wherein in said step b, an emitter/receiver is used to decide a coordinate position of said pen carriage which is displayed on a screen.

3. The automatic positioning/engraving method for a laser engraving machine as in claim 2, wherein said emitter/receiver is an infrared emitter/receiver.

4. The automatic positioning/engraving method for a laser engraving machine as in claim 1, wherein in said steps b and c, after positioning of an infrared emitter, said processor reads data fed back from a driving unit to decide a coordinate position of said pen carriage, and coordinate values of said coordinate position of said pen carriage are displayed on a screen.

5. An automatic positioning/engraving method for a laser engraving machine, wherein the step b includes the following steps:
using a red beam emitting device installed on the machine as a reference so that a red beam is emitted through the pen carriage, and the coordinates of the positioning points can be obtained by aligning the red beam onto the positioning points.
